SEQUENCE LISTING (37 sequences)

SEQ ID NO: 1 - DNA, 18 bp, Artificial
  Synthetic oligonucleotide
gaaaccgcaaggcatctg

SEQ ID NO: 2 - DNA, 18 bp, Artificial
  Synthetic oligonucleotide
cccacaattcccgctacc

SEQ ID NO: 3 - DNA, 20 bp, Artificial
  Synthetic oligonucleotide
ccacagccctagtatgaaag

SEQ ID NO: 4 - DNA, 21 bp, Artificial
  Synthetic oligonucleotide
tcaccgcatacagaatctaag

SEQ ID NO: 5 - DNA, 20 bp, Artificial
  Synthetic oligonucleotide
aaaacaaagggcacagcatc

SEQ ID NO: 6 - DNA, 20 bp, Artificial
  Synthetic oligonucleotide
gagaccaacgcaattcatca

SEQ ID NO: 7 - DNA, 20 bp, Artificial
  Synthetic oligonucleotide
atgcacggcatctgggaatc

SEQ ID NO: 8 - DNA, 24 bp, Artificial
  Synthetic oligonucleotide
gtcactgtcctgcaagttgctgtc

SEQ ID NO: 9 - DNA, 18 bp, Artificial
  Synthetic oligonucleotide
ccctctcctgggagcatt

SEQ ID NO: 10 - DNA, 21 bp, Artificial
  Synthetic oligonucleotide
aaagagaggaaggctctggtg

SEQ ID NO: 11 - DNA, 20 bp, Artificial
  Synthetic oligonucleotide
atcccccaattctctggaac

SEQ ID NO: 12 - DNA, 20 bp, Artificial
  Synthetic oligonucleotide
attggggaactccagacaca

SEQ ID NO: 13 - DNA, 19 bp, Artificial
  Synthetic oligonucleotide
agaaggctggggctcattt

SEQ ID NO: 14 - DNA, 20 bp, Artificial
  Synthetic oligonucleotide
ttcacacccatgacgaacat

SEQ ID NO: 15 - DNA, 19 bp, Artificial
  Synthetic oligonucleotide
gagcgaccagcacattcag

SEQ ID NO: 16 - DNA, 20 bp, Artificial
  Synthetic oligonucleotide
tataaaagcccgtcggtgtc

SEQ ID NO: 17 - DNA, 23 bp, Artificial
  Synthetic oligonucleotide
ggcttctaaatgtgttacggatg

SEQ ID NO: 18 - DNA, 20 bp, Artificial
  Synthetic oligonucleotide
actgcccagttcgtttcagt

SEQ ID NO: 19 - DNA, 20 bp, Artificial
  Synthetic oligonucleotide
agactccggcctctatgctt

SEQ ID NO: 20 - DNA, 19 bp, Artificial
  Synthetic oligonucleotide
aggaggggagagcatctga

SEQ ID NO: 21 - DNA, 20 bp, Artificial
  Synthetic oligonucleotide
gcctgaacaagatgctctcc

SEQ ID NO: 22 - DNA, 21 bp, Artificial
  Synthetic oligonucleotide
ctacgggcatacggtttggtt

SEQ ID NO: 23 - DNA, 20 bp, Artificial
  Synthetic oligonucleotide
taccagctggatgtcgtgga

SEQ ID NO: 24 - DNA, 20 bp, Artificial
  Synthetic oligonucleotide
tggtgccatgattaccttca

SEQ ID NO: 25 - DNA, 19 bp, Artificial
  Synthetic oligonucleotide
aggctcccctggtgcatac

SEQ ID NO: 26 - DNA, 20 bp, Artificial
  Synthetic oligonucleotide
cgaggccaaagtctgctatc

SEQ ID NO: 27 - DNA, 19 bp, Artificial
  Synthetic oligonucleotide
agaaggctggggctcattt

SEQ ID NO: 28 - DNA, 20 bp, Artificial
  Synthetic oligonucleotide
ttcacacccatgacgaacat

SEQ ID NO: 29 - DNA, 20 bp, Artificial
  Synthetic oligonucleotide
ctccccagtctttcaggtgt

SEQ ID NO: 30 - DNA, 20 bp, Artificial
  Synthetic oligonucleotide
cagttgaggcagggtagagc

SEQ ID NO: 31 - DNA, 21 bp, Artificial
  Synthetic oligonucleotide
gcacaatgttaacaggccact

SEQ ID NO: 32 - DNA, 20 bp, Artificial
  Synthetic oligonucleotide
gcccctttcttgctcttctt

SEQ ID NO: 33 - DNA, 20 bp, Artificial
  Synthetic oligonucleotide
agcacggtaaaccccaatta

SEQ ID NO: 34 - DNA, 20 bp, Artificial
  Synthetic oligonucleotide
cgtgtcaggtagcggttgta

SEQ ID NO: 35 - DNA, 20 bp, Artificial
  Synthetic oligonucleotide
ttactgatggtccccacacc

SEQ ID NO: 36 - DNA, 20 bp, Artificial
  Synthetic oligonucleotide
ggtccccacaccaaagttgt

SEQ ID NO: 37 - DNA, 18 bp, Artificial
  Synthetic oligonucleotide
caaaggccccgttcacat

(19) United States
(12) Patent Application Publication
(10) Pub. No.: US 2008/0108044 A1
(43) Pub. Date: May 8, 2008

(54) IN VITRO DIFFERENTIATION OF HEMATOPOIETIC CELLS FROM PRIMATE EMBRYONIC STEM CELLS

(76) Inventors: Deepika Rajesh, Madison, WI (US); Aimen F. Shaaban, Madison, WI (US)

Correspondence Address: QUARLES & BRADY LLP, 33 E. MAIN ST, SUITE 900, P.O. BOX 2113, MADISON, WI, 53701-2113, US

(21) Appl. No.: 11/937,355

(22) Filed: Nov. 8, 2007

Related U.S. Application Data
(60) Provisional application No. 60/857,756, filed on Nov. 8, 2006.

(51) Int. Cl. A01N 1/00

(52) U.S. Cl. 435/1.1

(57) ABSTRACT

Methods and compositions of CD45-positive hematopoietic cells and hemangioblasts derived b)y culturing human or non-human primate embryonic stem cells under serum-free conditions in cytokine-rich differentiation medium containing fibroblast growth factor or a related growth factor.

### CROSS-REFERENCE TO RELATED APPLICATIONS

This application claims the benefit of U.S. Provisional Patent Application No. 60/857,756, filed Nov. 8, 2006, incorporated herein by reference as if set forth in its entirety.

### STATEMENT REGARDING FEDERALLY SPONSORED RESEARCH OR DEVELOPMENT

Not applicable.

### BACKGROUND

The invention relates generally to methods for obtaining hematopoletic lineage cells characterized as CD45-positive, CD45/CD31-positive or CD45/CD34-positive and hemangioblasts characterized as Flk-1-positive/VE-Cadherin-negative/CD45-negative from cultured human and non-human primate embryonic stem cells (ESCs), and more particularly to methods for obtaining hematopoietic cells from human and non-human primate ESCs.

Pluripotent ESCs that can differentiate into ectoderm, endoderm and mesoderm germ layer cells have been established for many mammalian species including mice, human and non-human primates. While non-human primate ESCs are known, the steps required to obtain hematopoietic precursor cells from such cells are not well understood. A better understanding of the hematoendothelial differentiation in non-human primates would offer opportunities to evaluate early hematopoiesis and to develop intraspecies methods for transplanting ESC-derived hematopoietic precursor cells having erythroid, myeloid and lymphoid characteristics in a closely-related, non-human species.

Non-human primates, such as rhesus macaque (Macaca mulatta), share >90% DNA homology with humans and have long been used as models for studies on human behavior, reproductive biology, embryology and various disease states. Nonetheless, efforts to induce conclusive hematopoietic differentiation from rhesus ESCs (rESCs) have been unsuccessful, notwithstanding success in generating hematopoietic stem cells (HSCs) from other ESCs obtained from other species, such as human ESCs (hESCs). See, e.g., Chadwick K, et al., “Cytokines and BMP-4 promote hematopoietic differentiation of human embryonic stem cells,” Blood 102:906-915 (2003); Kaufman D, et al. “Hematopoietic colony-forming cells derived from human embryonic stem cells,” Proc. Natl. Acad. Sci. USA 98:10716-10721 (2001); Wang L, et al., “Human embryonic stem cells maintained in the absence of mouse embryonic fibroblasts or conditioned medium are capable of hematopoietic development,” Blood 105:4598-4603 (2005); and Zambidis E, et al., “Hematopoietic differentiation of human embryonic stem cells progresses through sequential hematoendothelial, primitive, and definitive stages resembling human yolk sac development,” Blood 106:860-870 (2005).

Likewise, murine HSCs can be derived from murine ESCs (mESCs), but the processes by which mESCs differentiate and mature into hematopoietic cells differ from those of hESCs. When mESCs are removed from culture conditions that maintain them in an undifferentiated state, they spontaneously differentiate to form embryoid bodies (EBs) that further differentiate into HSCs. Alternatively, mESCs differentiate into HSCs without an intermediate EB stage when cultured on bone marrow stromal cells.

A few studies suggest some hematopoietic development in rESCs, but a temporal emergence of CD45-positive cells and characteristic colony forming cells (CFCs) from differentiating rESCs have not been observed. In addition, although these cells showed increased expression of CD34 and formed cobblestone-like colonies in secondary culture, they failed to form colonies in a standard methylcellulose assay. See, e.g., Honig G, et al., “Hematopoietic differentiation of rhesus monkey embryonic stem cells,” Blood Cells Mol. Dis. 32:5-10 (2004); Li F, et al., “Bone morphogenetic protein 4 induces efficient hematopoietic differentiation of rhesus monkey embryonic stem cells in vitro,” Blood 98:335-342 (2001); Lu S, et al., “Comparative gene expression in hematopoietic progenitor cells derived from embryonic stem cells,” Exp. Hematol. 30:58-66 (2002); Lu S, et al., “Hematopoietic progenitor cells derived from embryonic stem cells: analysis of gene expression,” Stem Cells 20:428-437 (2002); and Wang Z, et al., “Thrombopoietin regulates differentiation of rhesus monkey embryonic stem cells to hematopoietic cells,” Ann. N Y Acad. Sci. 1044:29-40 (2005).

Additionally, a study of hematopoietic differentiation in common marmoset (Callithrix jacchus) ESCs demonstrates strikingly similar findings to the findings in rESCs. Kurita R, et al., “Tall/Scl gene transduction using a lentiviral vector stimulates highly efficient hematopoietic cell differentiation from common marmoset (Callithrix jacchus) embryonic stem cells,” Stem Cells 24:2014-2022 (2006). However, recent reports have shown the generation of hematopoietic cells from cynomolgus monkey (Macaca fasicularis) ESC's using a single ESC line (CMK6). Hiroyama T, et al., “Long-lasting in vitro hematopoiesis derived from primate embryonic stem cells,” Exp. Hematol. 34:760-769 (2006); Umeda, K, et al., “Identification and characterization of hemoangiogenic progenitors during cynomolgus monkey embryonic stem cell differentiation.” Stem Cells 24:1348-1358 (2006); and Umeda K, et al., “Development of primitive and definitive hematopoiesis from nonhuman primate embryonic stem cells in vitro.” Development 131:1869-1879 (2004). These studies represent a departure from the non-human primate studies previously mentioned. Additionally, despite demonstrating evidence for hematopoietic differentiation, the protocols are quite complex and differ greatly from those used for hESC differentiation. The relevance of these studies to hESC biology remains unclear. Thus, the mechanisms underlying hematopoietic differentiation, expansion and self-renewal are not as well-defined in non-human primate ESCs as in hESCs.

Of particular interest herein is the role of fibroblast growth factors (FGFs). FGF signaling plays a dual role in maintenance and fate selection of ESCs. The first role of FGF signaling is best illustrated by the high levels of FGF-2 protein secreted by murine embryonic fibroblasts (MEFs). High levels of FGF-2 provide critical support for an undifferentiated expansion of hESCs and rESCs in co-culture with MEFs. FGF-2 synergizes with Noggin to suppress bone morphogenetic protein (BMP) signaling and differentiation. Moreover, high levels of exogenous FGF-2 supplementation in a chemically defined medium sustains the undifferentiated expansion of hESCs in the absence of MEFs or MEF-conditioned medium.

The second role of FGF signaling is illustrated in hematoendothelial differentiation of ESCs. FGF signaling is critical in the formation of hemangioblasts from murine ESCs. Faloon P, et al., “Basic fibroblast growth factor positively regulates hematopoietic development,” Development 127:1931-1941 (2000). Likewise, FGFR1−/− murine ESCs were capable of endothelial, but not hematopoietic differentiation. Magnusson P, et al., “Fibroblast growth factor receptor-1 expression is required for hematopoietic but not endothelial cell development,” Arterioscler. Thromb. Vasc. Biol. 25(5):944-949 (2005). These studies therefore suggest that the loss of FGFR1 expression impaired hemangioblast differentiation resulting in an attenuation of hematopoietic development. Moreover, BMP-4 was shown to be essential in the formation of hemangioblasts from hESCs, but only in the presence of FGF-2. Kennedy M., et al., “Development of the hemangioblast defines the onset of hematopoiesis in human ES cell differentiation cultures,” Blood 109:2679-2687 (2007). Thus, FGF-2 appears to play at least two pivotal roles in ESC biology. However, despite documentation of its contribution to the maintenance ESCs in an undifferentiated state, the role for FGF-2 in the hematoendothelial differentiation of hESCs and rESCs has not been examined.

For the foregoing reasons, there remains a need for consistent methods to differentiate human and non-human primate ESCs to HSCs and other differentiated hematopoietic cell types for use in translational research, transplant and regenerative medicine. It is particularly desired to obtain hematopoietic precursors and other cells derived from non-human primate ESCs for use in allogeneic transplantation studies in a well-characterized, non-human, model species that mimics the human hematopoietic system.

### BRIEF SUMMARY

In a first aspect, a method of generating hematopoietic lineage cells and hemanlgioblasts from primate (human and non-human primates) EBs is summarized as including the steps of forming embryoid bodies from embryonic stem cells, and then culturing the EBs under serum-free conditions in a differentiation medium that is supplemented periodically with fibroblast growth factor (FGF) in an amount sufficient to yield differentiated hematopoietic lineage cells and hemangioblasts.

In some embodiments of the first aspect, the differentiation medium includes at least stem cell factor (SCF), Flt-3 ligand (Flt-3) and bone morphogenetic protein-4 (BMP-4). In other embodiments of the first aspect, the differentiation medium also includes interleukin-3 (IL-3), interleukin-6 (IL-6) and granulocyte colony-stimulating factor (G-CSF). In still other embodiments of the first aspect, the differentiation medium includes at least SCF, Flt-3, BP-4, IL-3, IL-6 and G-CSF. Optionally, the differentiation medium lacks vascular endothelial growth factor (VEGF).

In some embodiments of the first aspect, the FGF is fibroblast growth factor-2 (FGF-2).

In some embodiments of the first aspect, the non-human primate is a rhesus macaque, although the methods apply to other non-human primates as well.

In some embodiments of the first aspect, the differentiation medium is changed about every four days.

In some embodiments of the first aspect, the EBs are cultured for about sixteen days in the differentiation medium.

In some embodiments of the first aspect, the differentiation medium is supplemented with FGF at least about every forty-eight hours. In other embodiments of the first aspect, the differentiation medium is supplemented with FGF daily.

When the primate is a non-human primate, the concentration of FGF in the medium is between about 1 ng/ml to about 100 ng/ml, or about 50 ng/ml. When the primate is a human primate, the concentration of FGF in the medium is between about 0.5 ng/ml to about 50 ng/ml, or about 10 ng/ml.

In some embodiments of the first aspect, the embryoid bodies are co-cultured with stromal cells. In other embodiments of the first aspect, the stromal cells are OP9 stromal cells.

In some embodiments of the first aspect, the embryoid bodies are cultured on a basement membrane matrix. In other embodiments of the first aspect, the basement membrane matrix is fibronectin, gelatin, lamanin or collagen, or combinations thereof. In still other embodiments of the first aspect, the basement membrane matrix is Matrigel®.

In some embodiments of the first aspect, the resulting hematopoietic cells are CD45-positive and, in other embodiments of the first aspect, they are also CD31-positive or CD34-positive.

In some embodiments of the first aspect, the resulting hematopoietic cells are FLK-1-positive, CD45-negative and VE-Cadherin-negative (hemangioblast), as well as committed hematopoietic precursors.

In a second aspect, a cultured population of primate hematopoietic lineage cells is summarized as a population of cells that are CD45-positive, CD45/CD31-positive or CD45/CD34-positive cells generated by the methods described herein.

In some embodiments of the second aspect, at least about 15% of the cells in the population are CD45-positive. Alternatively, at least about 20% of the cells in the population are CD45-positive. Alternatively still, at least about 25% of the cells in the population are CD45-positive.

In other embodiments of the second aspect, the cells have a full-length FGFR1 to soluble FGFR1 ratio (FGFR1_{α}:FGFR1ₛₒₗ) of at least 5.

In a third aspect, a cultured population of primate hematopoietic lineage cells is summarized as a population of cells that are FLK-1-positive, CD45-negative and VE-Cadherin-negative (hemangioblast), as well as committed hematopoietic precursors, generated by the methods described herein.

In some embodiments of the third aspect, at least about 5% of the cells in the population are FLK-1-positive, CD45-negative and VE-Cadherin-negative. Alternatively, at least about 10% of the cells in the population are FLK-1-positive, CD45-negative and VE-Cadherin-negative. Alternatively still, at least about 15% of the cells in the population are FLK-1-positive, CD45-negative and VE-Cadherin-negative.

These and other features, aspects and advantages of the present invention will become better understood from the description that follows. In the description, reference is made to the accompanying drawings, which form a part hereof and in which there is shown by way of illustration, not limitation, embodiments of the invention. The description of preferred embodiments is not intended to limit the invention to cover all modifications, equivalents and alternatives. Reference should therefore be made to the claims recited herein for interpreting the scope of the invention.

### BRIEF DESCRIPTION OF THE DRAWINGS

The invention will be better understood and features, aspects and advantages other than those set forth above will become apparent when consideration is given to the following detailed description thereof. Such detailed description makes reference to the following drawings, wherein:

FIGS. 1A-1B show embodiments for generating CD45-positive hematopoietic lineage cells and hemangioblasts from rESCs (FIG. 1A) and hESCs (FIG. 1B).

### DESCRIPTION OF PREFERRED EMBODIMENTS

The present invention relates to the inventors' observation that non-human primate ESCs exhibit different requirements for hematopoietic differentiation than hESCs. In fact, non-human primate ESCs pause during differentiation at the hemangioblast stage when cultured under conditions in which hESCs develop into hematopoietic cells. This observation suggests that the differentiation medium lacks a cytokine or a growth factor that influences differentiation of non-human primate ESCs into lineage-specific hematopoietic cells, including HSCs. For the first time, a balance between the concentration of FGF-2 and the administration of FGF-2 to a culture is shown to be critical for hematoendothelial differentiation from both human and non-human primate ESCs. A FGF-2 concentration to induce hematopoietic differentiation has been defined. Ultimately, the inventors herein show that hematoendothelial development corresponds to an optimal total exposure to FGF-2.

Unless defined otherwise, all technical and scientific terms used herein have the same meaning as commonly understood by one of ordinary skill in the art to which the invention belongs. Although any methods and materials similar to or equivalent to those described herein can be used in the practice or testing of the present invention, the preferred methods and materials are described herein.

As used herein, “hemangioblast” refers to cells that are FLK-1 positive, VE-Cadherin negative and CD45 negative cells, which are multipotent and are a common precursor to hematopoietic and endothelial cells.

As used herein, “hematopoietic progenitor cells” refers to those cells showing evidence of hematopoietic lineage commitment—that is, the cells are at least CD45-positive. In addition, co-expression of CD31 and CD45 in the absence of mature lineage markers (i.e., CD3, CD14, CD15, CD19, CD56 and glycophorin A) suggests the existence of early hematopoietic progenitor cells. Likewise, co-expression of CD34 and CD45 suggests the existence of early hematopoietic progenitor cells; however, CD34 is not itself specific for hematopoietic cells. As shown below in the Examples, the presence of hematopoietic cells was demonstrated by the presence of CD45-positive cells, as well as CD31/CD45-positive cells and CD34/CD45-positive cells.

As used herein, “fibroblast growth factor” or “FGF” refers to a class of cytokines that are heparin-binding proteins and that bind a family of tyrosine kinase receptor molecules, such as FGFR-1, FGFR-2, FGFR-3, FGFR-4, and even FGF-21.

As used herein, “about” means within 5% of a stated concentration range or within 5% of a stated time frame.

As used here, “an amount sufficient” means a concentration of FGF that produces a cell population in which at least 5% of the cells in the population are CD45-positive or in which at least 5% of the cells in the population are Flk-1-positive/VE-Cadherin-negative/CD45-negative.

Although FGFs contribute to maintaining human and non-human primate ESCs in an undifferentiated state, their role(s) in the hematoendothelial differentiation of rESCs has not been similarly examined. Differences in FGF signaling may thus explain the different requirements for hematopoietic differentiation between human and non-human primate ESCs.

It is herein demonstrated that human and non-human primate ESCs differentiate into lineage-specific hematopoietic cells and hemangioblasts by including in differentiation medium an amount of a FGF sufficient to produce hematopoietic cells and hemangioblasts. As shown below, rESCs differentiated into CD45-positive, CD45/CD31-positive and CD45/CD34-positive cells when exposed to a FGF concentration of between about 1.0 ng/ml to about 100 ng/ml. Likewise, hESCs differentiated into CD45-positive, CD45/CD31-positive and CD45/CD34-positive cells when exposed to a FGF concentration of between about 0.5 ng/ml to about 50 ng/ml. Daily supplementation of the differentiation medium is not required to provide these concentrations, as one can calculate a cumulative dose by taking into consideration the half-life of FGF. As disclosed herein, one can vary when FGF is given by considering the total concentration provided to a culture. For example, if a culture is supplemented with a total amount of 800 ng of FGF over a 16-day period, one would add about 50 ng each day for daily supplementation. However, if FGF is supplemented about every two days over the 16-day period, rather than daily, one would add about 100 ng for each supplementation. Ultimately, inventors showed that hematoendothelial development corresponded to an optimal total exposure to FGF-2.

Furthermore, and as described below, FGF-2 supplementation was not necessary throughout the entire culture period. In some examples, FGF-2 was provided for the entire culture period (i.e., 16 days). That is, FGF-2 was supplemented on days 0, 2, 4, 6, 8, 10, 12 and 14, with cells harvested on day 16. In other examples, FGF-2 was provided for only a portion of the culture period. That is, FGF-2 was supplemented on days 0, 2, 4, 6, and 8, with cells harvested on day 16. Alternatively, FGF-2 was supplemented on days 8, 10, 12, 14 and 16, with cells harvested on day 16. However, a single, bolus dose of FGF-2 was not sufficient for generating hematopoietic cells and hemangioblasts. Preferably, FGF-2 supplementation at constant doses, and at periodic and sequential intervals, augmented hematopoiesis.

Although higher concentrations of FGF reduced hematopoietic lineage commitment, the effect on hemangioblast development was also beneficial. Hemangioblast development was augmented in both hESCs and rESCs. While the inventors do not intend to be limited to a mechanism by which the methods operate, higher concentrations of FGF may result in more hemangioblasts, but fewer committed hematopoietic cells.

FGFs act primarily through high-affinity tyrosine kinase receptors designated as FGFR-1 (flg-1), FGFR-2 (bek), FGFR-3 and FGFR-4. It is also contemplated that in addition to FGFs, other cytokines or growth factors that stimulate the same intracellular pathways as FGF may also overcome the observed differential requirements for hematopoiesis in non-human primate ESCs. One example is WNT proteins, as FGF and WNT signaling cross paths in a canonical β-catenin pathway. Another example is BMPs (e.g., BMP-4), as this TGF-β family of proteins is involved in cross-signaling with FGFs.

The invention will be more fully understood upon consideration of the following non-limiting Examples.

### EXAMPLES

### Example 1

### Differential Requirements for Hematopoietic Commitment Between hESCs and rESCs

Methods:

Embryonic Stem Cells: (1). hESCs. An undifferentiated hESC cell line, H9 (WiCell Research Institute; Madison, Wis.), was maintained by co-culture with irradiated murine embryonic fibroblasts (MEFs) in DMEM/F12 (Invitrogen; Carlsbad, Calif.) supplemented with 20% FBS (Invitrogen), 1% nonessential amino acids (NEAA; Invitrogen), 1 mM L-glutaimine (Invitrogen), 0.1 mM β-mercaptoethanol (Sigma; St Louis, Mo.) and 4 ng/ml human FGF-2 (R&D Systems, Inc.; Minneapolis, Minn.), as described by Thomson et al. Thomson J, et al., “Embryonic stem cell lines derived from human blastocysts,” Science 282:1145-1147 (1998), incorporated herein by reference as if set forth in its entirety; see also Amit M, et al., “Clonally derived human embryonic stem cell lines maintain pluripotency and proliferative potential for prolonged periods of culture,” Dev. Biol. 227:271-278 (2000).

(2). rESCs. R366.4, R420 and R456 rESCs derived from in vivo, flushed blastocysts (WiCell Research Institute; see also, Thomson J & Marshall V, “Primate embryonic stem cells,” Curr. Top. Dev. Biol. 38:133-165 (1998), incorporated herein by reference as if set forth in its entirety), as well as ORMES7 rESCs isolated from in vitro-produced embryos (kindly provided by Don Wolf; Oregon National Primate Research Center; Portland, Oreg.; see also, Mitalipov S, et al., “Isolation and characterization of novel rhesus monkey embryonic stem cell lines,” Stem Cells 24:2177-2186 (2006), incorporated herein by reference as if set forth in its entirely), were maintained in an undifferentiated state by co-culture with irradiated MEFs in DMEM/F12 supplemented with 20% FBS (Hyclone; Logan, Utah), 1 mM glutamine, 0.1 mM β-mercaptoethanol and 1% NEAA, as described by Thomson et al. Thomson J, et al., “Isolation of a primate embryonic stem cell line,” Proc. Natl. Acad. Sci. USA 92:7844-7848 (1995), incorporated herein by reference as if set forth in its entirety.

(3). mESCs. Undifferentiated CJ7 mESCs (kindly provided by Stuart Orkin; Boston, Mass.) were maintained by co-culture with irradiated MEFs in gelatin-coated flasks in DMEM supplemented with 15% FBS (Hyclone), 1 mM sodium pyruvate (Invitrogen), 1% penicillin/streptomycin (Invitrogen), 2 mM L-glutamine, 1% NEAA and 100 μM 1-thioglycerol (Sigina). as described by Mikkola et al. Mikkola H, et al., “Expression of CD41 marks the initiation of definitive hematopoiesis in the mouse embryo,” Blood 101:508-516 (2003), incorporated herein by reference as if set forth in its entirety.

Maintenance of Undifferentiated rESC and hESC Feeder-Free Cultures: Initially, rESCs and hESCs were maintained as undifferentiated cells by passage on irradiated MEFs (rESC_{MEF} and hESC_{MEF}). The cells were then adapted to feeder-free culture by expanding them on Matrigel® (BD Biosciences; Bedford, Mass.)-coated plates as described by Xu et al. Xui C, et al., “Feeder-free growth of undifferentiated human embryonic stem cells,” Nat. Biotechnol. 19:971-974 (2001), incorporated herein by reference as if set forth in its entirety. rESC and hESC cultures growing on Matrigel® (rESC_{MAT} and hESC_{MAT}) were maintained in MEF-conditioned medium (MEF-CM) supplemented with 4 ng/ml FGF-2.

Preparation of MEF-CM: MEFs were harvested and irradiated at 40 Gy, and seeded at 55,000 cells/cm² in medium containing 80% KNOCKOUT-DMEM (KO-DMEM; Invitrogen), 20% KNOCKOUT serum replacement (Invitrogen), 1 mM L-glutamine, 0.1 mM β-mercaptoethanol and 1% NEAA. MEF-CM was collected and supplemented with 4 ng/nIL FGF-2. rESC_{MAT} and hESC_{MAT} cultures were fed daily with MEF-CM. Cultures were passaged before reaching confluence by incubation in 200 units/ml collagenase IV (Invitrogen) for 5 minutes at 37° C., dissociated and then seeded back onto fresh Matrigel®-coated plates.

Co-Culture on OP9 Stromal Cell Layers: rESC_{MAT} and hESC_{MAT} were seeded on confluent OP9 stromal cell layers as described by Vodyanik et al. Vodyanik M, et al., “Human embryonic stem cell-derived CD34+ cells: efficient production in the coculture with OP9 stromal cells and analysis of lymphohematopoietic potential,” Blood 105:617-626 (2005); see also, Nakano T, et al., “Generation of lymphohematopoietic cells from embryonic stem cells in culture,” Science 265:1098-1101 (1994), each of which is incorporated herein by reference as if set forth in its entirety. Briefly, OP9 stromal cells were maintained in α-minimal essential medium (αMEM) containing 15% FBS. The cells were allowed to reach confluence at least three days prior to plating rESC_{MAT} or hESC_{MAT} cells. On the day of plating, the medium was changed to αMEM supplemented with 1 mM L-glutamine, 50 μg/ml ascorbic acid (Sigma), 20% BIT 9500 (StemCell Technologies; Vancouver, B.C. Canada) and 450 μM monothioglycerol (MTG; Invitrogen). For cytokine-supplemented OP9 stromal cell co-cultures, the following cytokines were added to the medium: 150 ng/ml SCF (R&D Systems); 150 ng/ml Flt-3 (R&D Systems), 10 ng/ml IL-3 (R&D Systems), 10 ng/ml IL-6 (R&D Systems), 50 ng/ml G-CSF (R&D Systems) and 20 ng/ml BMP-4 (R&D Systems). The medium was replaced every fourth day, and cells were harvested on days four to sixteen using collagenase IV.

EB Culture: Undifferentiated rESCs and hESCs adapted to feeder-free growth on Matrigel®-coated plates were harvested at confluence with collagenase IV. To promote EB formation, the cells were transferred to 6-well, low-attachment plates for an overnight incubation in a differentiation medium that was KO-DMEM supplemented with 20% BIT 9500, 1% NEAA, 1 mM L-glutamine and 0.1 mM β-mercaptoethanol. The next day, cultures were fed fresh differentiation medium alone (control) or were fed fresh differentiation medium supplemented with the following growth factors and cytokines: 150 ng/ml SCF; 150 ng/ml Flt-3, 10 ng/ml IL-3, 10 ng/ml IL-6, 50 ng/ml G-CSF and 20 ng/ml BMP-4. The medium was changed every 4 days by transferring the EBs into a 15-ml tube and allowing the aggregates to settle for 5 minutes. The supernatant was aspirated and replaced with fresh differentiation medium with supplements. Cells were harvested on days four to sixteen using collagenase IV. 100054] Undifferentiated mESCs were maintained in feeder-free culture on gelatin-coated plates in the presence of leukemia inhibitory factor (LIF; Chemicon; Temecula, Calif.). To promote EB formation, cells were harvested using trypsin and then seeded in low attachment plates in DMEM containing the following: 15% FBS, 1 mM L-glutamine, 1% sodium pyruvate, 0.75% BSA (Fraction V), 450 μM MTG and 20% BIT9500. The next day, cultures were given fresh differentiation medium alone (control) or differentiation medium supplemented with the following growth factors and cytokines: 50 ng/ml SCF, 10 ng/ml IL-3, 10 ng/ml IL-6, 5 ng/ml G-CSF, 5 ng/ml G-CSF (R&D Systems), 10 ng/ml VEGF (R&D Systems), 10 ng/ml thrombopoietin (TPO; R&D Systems) and 10 ng/ml erythropoietin (EPO; R&D Systems). The cells were fed every fourth day and harvested after sixteen days of EB culture.

Flow Cytometry: Cells were washed with medium and treated with trypsin (Invitrogen) and collagenase IV for 20 minutes in a 37° C. incubator, followed by washes with medium and passed through a 70-μm cell strainer. The cells were re-suspended at approximately 2×10⁵ cells/ml and stained with the following fluorochrome-conjugated monoclonal antibodies: anti-human CD31 (WM-59; eBioscience; San Diego, Calif.); anti-human CD34 (563; BD Biosciences; San Jose, Calif.); anti-human CD38 (HIT2; eBioscience); anti-human CD41 (HIP8; eBioscience); anti-human CD43 (L10; eBioscience); anti-human CD45 (D058-1283; BD Biosciences); anti-human CD117 (YB5.B8; eBioscience); anti-human flk-1 (89106; R&D Systems; Minneapolis, Minn.); and anti-human Oct3/4 (240408; R&D Systems); and anti-human SSEA-4 (MC-813-70; R&D Systems). Human-rhesus cross-reactivity was confirmed using rhesus tissue samples. Non-viable cells were excluded with 7-aminoactinomycin D (7-AAD; BD Biosciences). Live cell analysis was performed on a FACSCalibur™ flow cytometer with CellQuest™ software (BD Biosciences).

For intracellular staining, cells were harvested using trypsin and collagenase IV, washed with PBS and fixed with 2% paraformaldehyde (Sigma-Aldrich; St. Louis, Mo.) for 20 minutes on ice. The cells were washed with PBS and then washed with SAP buffer (PBS containing 2% FCS and 0.2% saponin (SAP; (Sigma-Aldrich). The cells were then stained with goat anti-Oct-3/4 (R&D Systems) in SAP buffer for 30 minutes at 4° C., and then washed twice with SAP buffer. For visualization, the cells were then incubated with a FITC-conjugated, isotype specific, anti-rat IgG₂b secondary antibody (BD PharMingen; San Diego, Calif.) for 30 minutes at 4° C. prior to washing and analysis on a FACSCalibur™ flow cytometer with CellQuest™ software. For negative controls, primary antibody was omitted.

Clonogenic Hematopoietic Progenitor Assay: rEBs and hEBs were dispersed into single cell suspensions using 1 mg/ml collagenase IV and 0.05% trypsin/EDTA. Viable cells were quantified, plated (3.0×10⁵ cells/ml) and assayed in humidified chambers for hematopoietic CFCs using Human Methylcellulose Complete Medium (R&D Systems) containing 50 ng/ml SCF, 3 U/ml EPO, 10 ng/ml G-CSF and 10 ng/ml IL-3.

Colony Histology: Individual colonies growing on methylcellulose were picked using a pulled-tip, glass micropipette. Each colony was placed in a 1.5 ml centrifuge tube with 1 ml of PBS. Cell clumps were dissociated by incubation with 0.05% trypsin for 5 minutes. Cytospins were obtained by washing the cells and re-suspending them in 300 μl of medium. They were then loaded on Cytoclips (Thermo Scientific; Waltham, Mass.) and centrifuged at 800 rpm for 5 minutes. Cells were fixed on the cytospins and then stained with Wright-Giemsa reagents (Hema 3 stain; Fisher Scientific; Hampton, N.H.) according to the manufacturer's instructions.

For immunofluorescence staining, the cytospins were washed twice with PBS and fixed for 10 minutes in PBS containing 2% paraformaldehyde. The fixed cells were washed with PBS and incubated with biotin-conjugated anti-VE-Cadherin (16B1; eBioscience) and FITC-conjugated anti-CD45 (D058-1283; BD Biosciences) for 1 hour, washed 5 times and incubated with Streptavidin-Alexa Fluor 546 (Invitrogen) for another 45 minutes. Following the second staining step, the cells were washed and then mounted using anti-FADE gold (Invitrogen). Images were acquired using a MRC 1024ES confocal microscope (Bio-Rad, Richmond, Calif.). Cells incubated with Streptavidin-Alexa Fluor 546 alone and IgG₁-FITC served as controls. For acetylated LDL staining, the colonies were plucked from methylcellulose and re-plated in a Matrigel®-coated slide flask (Nalgene; Rochester, N.Y.) for two days. Aseptically, dil-acetylated low density lipoprotein (Ac-LDL, Biomedical Technologies; Stoughton, Mass.) was diluted to 10 μg/ml in medium, was added to the live cells and then was allowed to incubate for 4 hours at 37° C. The medium was removed, the cells were washed several times with medium and mounted using anti-FADE gold, and then visualized using standard rhodamine excitation-emission filters via confocal microscopy.

qRT-PCR Analysis: Total RNA was isolated from undifferentiated rESCs and day 16 rhesus EB cultures using RNAqueous®-4PCR Kit (Ambion; Austin, Tex.). RNA was treated with RNase-free DNase at the last step of the reaction. cDNA was synthesized using an iScript cDNA Synthesis Kit (Bio-Rad). qRT-PCR was performed using iQ™ SYBR®-Green Supermix reagents and an iCycler® Thermal Cycler and software (Bio-Rad, Hercules, Calif.).

TABLE 1

Rhesus-specific primers.

| | |
|---|---|
| Gene | Primer Sequence |

| | |
|---|---|
| GATA-1 | 5′-GAAACCGCAAGGCATCTG-3′ |
| | (Forward; SEQ ID NO: 1) |
| | 5′-CCCACAATTCCCGCTACC-3′ |
| | (Reverse; SEQ ID NO: 2) |
| GATA-2 | 5′-CCACAGCCCTAGTATGAAAG-3′ |
| | (Forward; SEQ ID NO: 3) |
| | 5′-TCACCGCATACAGAATCTAAG-3′ |
| | (Reverse; SEQ ID NO: 4) |
| SCL | 5′-AAAACAAAGGGCACAGGATC-3′ |
| | (Forward; SEQ ID NO: 5) |
| | 5′-GAGACCAACGCAATTCATCA-3′ |
| | (Reverse; SEQ ID NO: 6) |
| FLK-1 | 5′-ATGCACGGCATCTGGGAATC-3′ |
| | (Forward; SEQ ID NO: 7) |
| | 5′-GTCACTGTCCTGCAAGTTGCTGTC-3′ |
| | (Reverse; SEQ ID NO: 8) |
| RUNX-1 | 5′-CCCTCTCCTGGGAGCATT-3′ |
| | (Forward; SEQ ID NO: 9) |
| | 5′-AAAGAGAGGAAGGCTCTGGTG-3′ |
| | (Reverse; SEQ ID NO: 10) |
| PU.1 | 5′-ATCCCCCAATTCTCTGGAAC-3′ |
| | (Forward; SEQ ID NO: 11) |
| | 5′-ATTGGGGAACTCCAGACACA-3′ |
| | (Reverse; SEQ ID NO: 12) |
| GAPDH | 5′-AGAAGGCTGGGGCTCATTT-3′ |
| | (Forward; SEQ ID NO: 13) |
| | 5′-TTCACACCCATGACGAACAT-3′ |
| | (Reverse; SEQ ID NO: 14) |

All primers were tested and optimized for specificity with rhesus samples and for non-reactivity with SYBR®-Green reagents using non-reverse-transcribed cDNA. Briefly, for each reaction, 12.5 μl of the SYBR®-Green PCR Master Mix (Bio-Rad) was mixed with 10 μl of each primer (for each gene of interest or GAPDH), and reverse transcribed cDNA. The thermal cycling conditions comprised a hot start step at 95° C. for 3 minutes. Cycle conditions were 30 seconds at 95° C. and 30 seconds at 58° C. Each sample underwent forty cycles of amplification. All qRT-PCR reactions were confirmed for specificity of a single PCR product by analysis on 2% agarose gels. Comparative quantification of each target gene was performed based on cycle threshold (CT) normalized to GAPDH using a delta CT method. Pfaffl M, “A new mathematical model for relative quantification in real-time RT-PCR,” Nucleic Acids Res. 29:e45 (2001). The relative expression of each normalized target gene was compared with the GAPDH-normalized expression of the target gene. Fold change expression from undifferentiated rESCs was calculated as 2-^{ΔΔ}CT, where ^{ΔΔ}CT equals ^{Δ}CT (of differentiated ESCs)-^{Δ}CT (of undifferentiated ESCs).

Results:

In preliminary studies, we found that even a small number of MEFs significantly inhibited hematopoietic differentiation of rESCs. As such, rESCs (R366.4, R456, R420 and ORMES-7) and hESCs were expanded on irradiated MEFs and adapted to feeder-free growth on Matrigel®-coated plates. The cells maintained a normal karyotype after nearly twenty passages. Moreover, undifferentiated rESCs demonstrated a phenotype similar to hESCs when expanded on Matrigel®.

Following expansion on Matrigel®, undifferentiated ESCs (rESCs (R366.4) and hESCs) were harvested and analyzed for expression of antigens associated with pluripotency (e.g., CD117, SSEA-4 and Oct3/4), for expression of antigens associated with early hematoendothelial differentiation (e.g., CD31, CD34 and flk-1) and for expression of antigens associated with hematopoietic lineage commitment (e.g., CD38, CD41 and CD45).

As shown in Table 2, undifferentiated rESC_{MAT} and hESC_{MAT} were completely devoid of CD45 expression, but expressed a low frequency of CD34 and flk-1, suggesting some heterogeneity among rESCs and hESCs. rESC_{MAT} and hESC_{MAT} displayed a slightly higher frequency of flk-1⁺ cells in culture, but an otherwise similar differentiation profile when compared to ESCs maintained on MEFs. As expected Oct-4, CD117 and SSEA-4 were highly expressed in undifferentiated rESCs and hESCs, regardless of how they were maintained.

TABLE 2
Cell Surface Marker Expression of Undifferentiated rESCs and hESCs.

| Marker | rESC_{MEF} | rESC_{MAT} | hESC_{MEF} | hESC_{MAT} |
|---|---|---|---|---|
| CD117 | Low | Low | Low | Low |
| SSEA-4 | Strong | Strong | Strong | Strong |
| Oct3/4 | Strong | Strong | Strong | Strong |
| CD31 | Weak | Weak | Weak | Weak |
| CD34 | Weak | Weak | Weak | Weak |
| FLK-1 | Weak | Low | Weak | Low |
| CD38 | Weak | Weak | Weak | Weak |
| CD41 | Weak/None | Weak/None | Weak/None | Weak/None |
| CD45 | None | None | None | None |

Weak: 0.1-0.4% of the cells express the marker
Low: 0.5-4% of the cells express the marker
High: >5% of the cells express the marker

rESCs differentiated on OP9 stromal cells lacked phenotypic and functional hematopoietic properties. Although CD34⁺ (3%) cells could be detected at low levels, no CD45⁺ cells were detected (<0.3%), despite nearly 3 weeks of OP9 co-culture (Table 3). Subsequent plating of differentiating rESCs in a methylcellulose culture resulted in extensive networks of endothelial cells. Conversely, hESCs grown under identical conditions resulted in dramatic hematopoietic differentiation, demonstrated by a high frequency of flk-1⁺ (46%), CD45⁺ (21%), CD34⁺ (47%), CD41⁺ (26%) and CD38⁺ (9%) cells with down-regulation of c-Kit. Thus, unlike hESCs, co-culture of rESCs with OP9 stromal cells did not result in clear hematopoictic differentiation, but instead exhibited a bias towards endothelial differentiation.

TABLE 3
Cell Surface Marker Expression of OP9-Differentiated rESCs and
hESCs.

| Marker | rESCs | hESCs |
|---|---|---|
| CD117 | Low | Low |
| SSEA-4 | — | — |
| Oct3/4 | — | — |
| CD31 | Weak | Strong |
| CD34 | Low | Strong |
| FLK-1 | Low | Strong |
| CD38 | Weak | Low |
| CD41 | Weak/None | Strong |
| CD45 | None | Strong |

Weak: 0.1-0.4% of the cells express the marker
Low: 0.5-4% of the cells express the marker
High: >5% of the cells express the marker

Cytokine supplementation of EB cultures improved hematopoietic differentiation of rESCs, albeit to a lesser degree than in hESC. As shown in Table 4, rhesus EB (rEB) cultures without cytokine supplementation demonstrated low levels of CD34⁺ (<0.5%) and essentially undetectable levels of CD38, CD41, CD43 and CD45, despite more than 3 weeks in culture. Under the same conditions, human EB (hEB) cultures demonstrated modest hematopoietic differentiation, as the hEBs were CD34⁺ (6.7%), CD31⁺ (5.6%) and CD45⁺ (4.14%).

Conversely, rEBs formed from rESC_{MAT} in the presence of cytokines (e.g., BMP-4, SCF, Flt-3, IL-3, IL-6 and G-CSF) demonstrated a decrease in SSEA-4 frequency (60% to 12%) with a concomitant, yet slight, rise in the frequencies of CD41⁺ and CD34⁺ (3%) cells. Additionally, and for the first time, detectable frequencies of CD45⁺ cells were observed, beginning at EB day 12 and continuing to EB day 22 (0.18% -0.98%) in the presence of cytokines. hEBs formed from hESC_{MAT} revealed a robust hematopoietic differentiation with higher frequencies of CD31-positive (18.0±4.7%), CD34-positive (10.0±1.7%) and CD45-positive (20.0±7.2%) cells in the presence of cytokines.

TABLE 4
Cell Surface Marker Expression of Differentiated rEBs and hEBs
Exposed to Cytokines.

| | rEBs | rEBs | hEBs | hEBs |
|---|---|---|---|---|
| Marker | w/o cytokines | w/cytokines | w/o cytokines | w/cytokines |
| CD117 | Low | Low | Low | Low |
| SSEA-4 | High | Low | Low | Low |
| Oct3/4 | — | — | — | — |
| CD31 | Weak/None | Weak | Low | High |
| CD34 | Weak | Low | Low | High |
| Flk-1 | None | Low | Low | High |
| CD38 | Weak/None | Weak | Low | High |
| CD41 | Weak | Weak | Weak | Low |
| CD45 | None | Weak | Low | High |

Weak: 0.1-0.4% of the cells express the marker
Low: 0.5-4% of the cells express the marker
High: >5% of the cells express the marker

rESCs, however, demonstrated a lower capacity for hematopoietic differentiation in EB culture compared to hESCs or mESCs. Under similar EB culture conditions, both hEBs and murine EBs (mEBs) demonstrated robust hematopoietic differentiation, as approximately one fourth of the cultured cells expressed CD45. Significantly lower levels of CD45 expression were observed in the differentiating rEBs when compared to either hEBs or mEBs. Surprisingly, the differentiation profile of hEBs was closer to mEBs than to those derived from the rESC lines tested (i.e., R366.4, R420 and R456).

To evaluate the possibility that rESCs simply require more time in culture to demonstrate significant hematopoietic lineage commitment, rEBs (R366.4, R456 and R420) were maintained with cytokine supplementation for up to seven weeks. Higher levels of CD34⁺ cells were observed in all three rESCs; however, increases in CD34 expression were not associated with a hematopoietic lineage commitment. CD45 expression decreased from 3.63% to 0.66% in R420 cells, but remained relatively unchanged in the other tvo rESCs (R366.4 and R456). In addition, CD31 expression decreased in R456 (4.4% to 0.7%) and R420 (3.48 to 0.32%) rEBs.

Cytokine supplementation of OP9 stromal cell co-cultures slightly lowered CD34⁺ and CD41⁺ frequencies in rESCs, but increased frequency of flk-1⁺ cells. Increased flk-1 frequency suggests enhanced development of hematopoietic mesoderm; however, CD45⁺ cells remained undetectable. Also, rESCs subjected to 4 weeks of OP9 stromal cell co-culture in the absence of cytokines demonstrated a rapid expansion of CD34⁺ cells (76% of mixed culture at 28 days), although CD45 expression still remained undetectable.

rEBs expressed a transcriptional profile consistent with hemangioblast differentiation, displaying both hematopoietic and endothelial differentiation in semisolid clonogenic culture. Expression of transcription factors (e.g., SCL/Tal-1, GATA-1, GATA-2, PU.1 and RUNX1—all associated with hematoendothelial development and subsequent lineage commitment) was measured in two lines of undifferentiated rESCs (R366.4 and R420) and compared to day 16 rEBs cultured in cytokine-enriched medium. As shown in Table 5, rEBs demonstrated an up-regulation of factors associated with early hematoendothelial development, as evidenced by increased GATA-1, GATA-2, SCL and Flk-1 expression with a dramatic fall in Oct-3/4 expression. However, absence of hematopoietic lineage commitment was demonstrated by a lack of up-regulation of either RUNX1 or PU.1 in two of the three lines studied (R456 and R366.4). Interestingly, PU.1 was upregulated in the third group of rEBs (R420), which also demonstrated highest expression of CD45 when exposed to FGF-2. Thus, in the absence of FGF-2, R420 yielded low levels of CD45 expression, with a large portion of cells arrested at the hematoendothelial stage of development. However, supplementation with FGF-2 increased CD45 expression and helped the cells overcome the block.

TABLE 5
Transcription Factor Expression in rEBs vs Undifferentiated rESCs.

| Transcription Factor | R366.4 | R420 |
|---|---|---|
| SCL/Tal-1 | Moderately up-regulated | Strongly up-regulated |
| GATA-1 | Moderately up-regulated | Weakly up-regulated |
| GATA-2 | Weakly up-regulated | Moderately up-regulated |
| PU.1 | Down-regulated | Weakly up-regulated |
| RUNX1 | Down-regulated | Down-regulated |
| Oct3/4 | Down-regulated | — |
| Flk-1 | — | Strongly upregulated |

When plated in methylcellulose, robust hematopoietic colony formation was observed from both hEBs and mEBs. However, rEBs formed colonies of mixed erythroid, myeloid and endothelial cell types, signaling the existence of bi-potential hematoendothelial progenitors. For example, loosely adherent cells in hematoendothelial colonies displayed erythroid or macrophage morphology on examination of Wright stains.

rEBs were stained for antigens associated with endothelial (VE-Cadherin and Ac-LDL) or hematopoietic lineage commitment (CD45). Small rounded cells characteristic of hematopoietic morphology expressed only CD45 without VE-Cadherin. Conversely, cells exhibiting endothelial morphology expressed VE-Cadherin brightly without CD45 expression. Cells were also triple stained with CD45, VE-Cadherin and Ac-LDL. Taken together, these findings indicate that exposure of the rEBs to the cytokines described above resulted in an abundant development of bi-potential hematoendothelial progenitors, with only limited commitment to definitive hematopoietic lineages. Despite the presence of CD45, rEBs demonstrated a “pause” in hematoendothelial differentiation, thereby illustrating a point of divergence from patterns of hematopoietic differentiation seen in mEBs and hEBs under similar conditions.

### Example 2

### FGF-2 Enhanced Hematopoietic Differentiation of hESCs and rESCs

Methods:

ESCs: hESCs (i.e., H9) and rESCs (i.e., R420, R456 and ORMES-7) cell lines are described above.

EB Culture: EB culture conditions and methods are described above. In this Example, however, FGF-2 (R&D Systems) was added to the cytokine-rich, differentiation medium described above. Briefly, undifferentiated hESCs and rESCs were subjected to EB differentiation with daily FGF-2 supplementation of the differentiation medium, although daily supplementation was not required. rESCs were exposed daily to FGF between 1.0 ng/ml to 100 ng/ml. Similarly, hESCs were exposed to daily to FGF between 0.5 ng/ml to 50 ng/ml. In a separate experiment, undifferentiated hESCs and rESCs were subjected to EB differentiation and then cultured were cultured with serial increases of FGF-2 (i.e., 0, 10, 50 and 100 ng/ml) to the cytokine-rich medium for sixteen days.

Flow Cytometry: Flow cytometry was preformed as described above. Briefly, cultures were analyzed by flow cytometry after sixteen days of EB culture. Control cells were cultured in an identical manner in cytokine-rich medium, but without FGF-2.

Results:

After sixteen days, and as compared to controls (which were not cultured with FGF-2), FGF-2-supplemented cultures appeared more robust with an overall higher number of cells. More importantly, a dramatic expansion of hematoendothelial precursors (Flk1⁺, VE-Cadherin⁻ and CD45⁻), committed hematopoietic progenitors (CD34⁺, CD45⁺ and Lin⁻) and hematopoietic cells (CD45⁺) were seen in FGF-2 supplemented cultures. Importantly, CD45-positive cells were present at approximately day eight of culture. As shown Table 6, the effects of FGF-2 on R420 rESCs were significant.

TABLE 6
Cell Surface Marker Expression of Differentiated R420 Cells Exposed
to FGF-2.

| | Cytokine-rich medium | Cytokine-rich medium |
|---|---|---|
| Marker | w/o FGF-2 | w/FGF-2 |
| CD45 | Weak | Strong |
| CD45/CD34 | Weak | Strong |
| FLK⁺/CD45⁻/ | Weak | Strong |
| VE-cadherin⁻ | | |

Weak: 0.1-0.4% of the cells express the marker
Low: 0.5-4% of the cells express the marker
High: >5% of the cells express the marker

Moreover, serial increases in FGF-2 concentration (i.e., 0, 10, 50 and 100 ng/ml) of the cytokine-rich medium caused concentration-dependent increases in hematopoietic differentiation of both hESCs and rESCs. Both the development of hematoendothelial precursors and the differentiation of committed hematopoietic cell types were augmented. As such, FGF-2 significantly influenced hematopoietic differentiation of hESCs and rESCs.

### Example 3

### Role of FGF-2 in Hematopoietic Differentiation of rESCs

Methods:

ESCs: hESCs (i.e., H9) and rESCs (i.e., R420, R456 and ORMES-7) cell lines are described above and were maintained by co-culture with irradiated MEFs in DMEM supplemented with 15% FBS (Hyclone), 1 mM glutamine, 0.1 mM β-mercaptoethanol and 1% NEAA. The cell lines were adapted to feeder-free culture by allowing them to expand on Matrigel®-coated plates, as previously described, with 4 ng/ml FGF-2. Rajesh D, et al., “Differential requirements for hematopoietic commitment between human and rhesus embryonic stem cells,” Stein Cells 25:490-499 (2007); and Xu R, et al., “Basic FGF and suppression of BMP signaling sustain undifferentiated proliferation of human ES cells,” Nat. Methods 2:185-190 (2005), each of which is incorporated herein by reference as if set forth in its entirety.

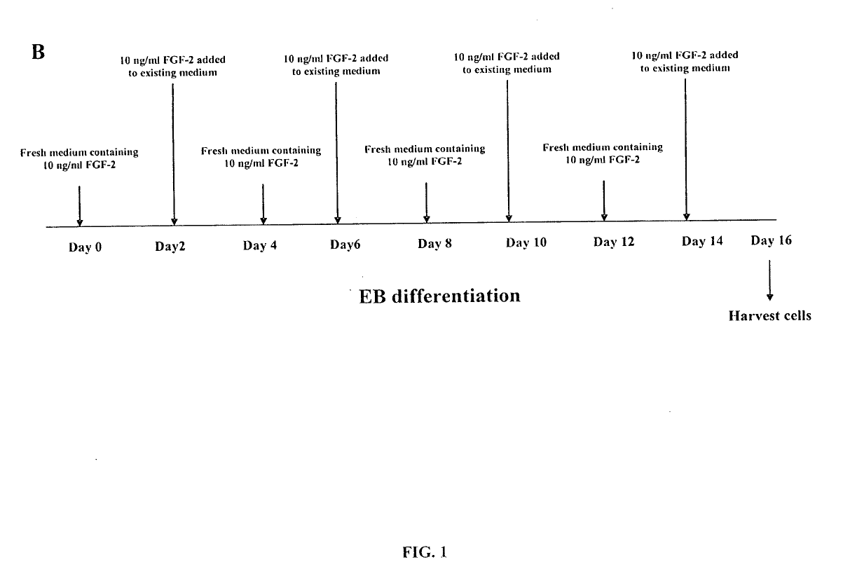

EB Culture: The EB culture conditions and methods are described above. Briefly, undifferentiated ESCs were harvested at confluence with collagenase IV. EBs were allowed to form in low attachment plates according to the method outlined by Xu et al., supra. using KO-DMEM supplemented with 20% BIT 9500, 1% NEAA (Invitrogen), 1 mM L-glutamine and 0.1 mM β-mercaptoethanol. The next day, cultures were fed fresh differentiation medium alone (control) or were fed fresh differentiation medium supplemented with the following growth factors and cytokines: 150 ng/ml SCF, 150 ng/ml Flt-3, 10 ng/ml IL-3, 10 ng/ml IL-6, 50 ng/ml G-CSF and 20 ng/ml BMP-4. The medium was changed every four days. FGF-2 was added at various concentrations (0, 10, 50 and 100 ng/ml) to the differentiating medium on either day 0 or day 8 or EB culture. FGF-2 was supplemented to the cultures every 48 hours. Thus, FGF-2 was added at either day 0 or day 8, and then supplemental FGF-2 treatments were performed every 48 hours (as shown in FIG. 1).

Flow Cytometry: Flow cytometry was preformed as described above. However, cells were stained with fluorochrome-conjugated monoclonal antibodies including the following: anti-human CD31; anti-human CD34 (BD Biosciences); anti-human CD45; anti-non-human primate CD45; anti-FGFR1 (QED Biosciences; San Diego, Calif.); anti-human Flk-1; and anti-VECadherin (eBiocience; San Diego, Calif.).

Real-time quantitative PCR to detect FGFR1 splice variants: Total RNA was isolated from 1.0-1.2×10⁶ undifferentiated or differentiated rESCs or hESCs that were cultured either in the presence or absence of FGF-2 using a RNAqueous-4 PCR Kit (Ambion; Austin, Tex.). RNA was then subjected to a DNase reaction to eliminate any contaminating genomic DNA using a Turbo DNA-Free Kit (Ambion). RNA was quantified by spectrophotometry and 0.5 μg of RNA was used for cDNA synthesis using an iScript cDNA Synthesis Kit (Bio-Rad). qRT-PCR was performed with iQ SYBR®-Green Supermix reagents (Bio-RAd) according to the manufacturer's protocol using 0.5 μg of cDNA per reaction on an iCycler® Thermal Cycler and software (Bio-Rad). Primer information for FGFR-1 isoforms, GATA-1, GATA-2, SCI, PU.1 and Runx is listed in the table below. Sequence alignment and processing for primer design was performed using Geneious Pro (Biomatters Ltd.; Auckland, New Zealand); primers were designed using Primer3 (Whitehead Institute; Cambridge, Mass.). All primers have been confirmed to cross-react with human and rhesus DNA. The absence of genomic DNA amplicons or primer dimer amplicons that could interfere with accurate amplification measurements was confirmed by gel electrophoresis. All PCR reactions were performed with 1 cycle at 95° C. for 3 minutes, followed by 40 cycles at 95° C. for 30 seconds, 60° C. for 30 seconds, 72° C. for 30 seconds, followed by 1 cycle at 95° C. for 1 minute and 1 cycle at 55° C. for 1 minute. Comparative quantification of each target gene was performed based on cycle threshold (CT) normalized to GAPDH using a delta CT method, described above. See, Pfaffl, supra.

TABLE 7

Human- and rhesus-specific primers.

| | | | | | | |
|---|---|---|---|---|---|---|
| | | | | | Melting | Amplicon |
| Gene/ | Species | | | 5′ | Temp | Size |
| Isoform | Specificity | GenBank | Sequence | position | (° C.) | (bp) |

| | | | | | | |
|---|---|---|---|---|---|---|
| FGF1 | Human/Rhesus | NN_000800 | 5′-GAGCGACCAGCACATTCAG-3 | 297 | 60.6 | 110 |
| | | | (Forward; SEQ ID NO: 15) | | | |
| | | | 5′-TATAAAAGCCCGTCGGTGTC-3′ | 407 | 60.0 | |
| | | | (Reverse; SEQ ID NO: 16) | | | |
| FGF2 | Human/Rhesus | NM_002006 | 5′-GGCTTCTAAATGTGTTACGGATG-3′ | 743 | 59.9 | 122 |
| | | | (Forward; SEQ ID NO: 17) | | | |
| | | | 5′-ACTGCCCAGTTCGTTTCAGT-3′ | 845 | 59.8 | |
| | | | (Reverse; SEQ ID NO: 18) | | | |
| FGFR1_{α} | Human/Rhesus | NM_023110 | 5′-AGACTCCGGCCTCTATGCTT-3′ | 1224 | 60.4 | 91 |
| | | | (Forward; SEQ ID NO: 19) | | | |
| | | | 5′-AGGAGGGGAGAGCATCTGA-3′ | 1315 | 59.9 | |
| | | | (Reverse; SEQ ID NO: 20) | | | |
| FGFR1_{β} | Human/Rhesus | NM_023105 | 5′-GCCTGAACAAGATGCTCTCC-3′ | 1023 | 60.0 | 106 |
| | | | (Forward; SEQ ID NO: 21) | | | |
| | | | 5′-CTACGGGCATACGGTTTGGTT-3′ | 1129 | 59.9 | |
| | | | (Reverse; SEQ ID NO: 22) | | | |
| FGFR1ₛₒₗ | Human/Rhesus | NM_023107 | 5′-TACCAGCTGGATGTCGTGGA-3′ | 1402 | 62.7 | 224 |
| | | | (Forward; SEQ ID NO: 23) | | | |
| | | | 5′-TGGTGCCATGATTACCTTCA-3′ | 1626 | 59.9 | |
| | | | (Reverse; SEQ ID NO: 24) | | | |
| FGFR1_{DNTK} | Human/Rhesus | NM_023109 | 5′-AGGCTCCCCTGGTGCATAC-3′ | 2594 | 62.4 | 90 |
| | | | (Forward; SEQ ID NO: 25) | | | |
| | | | 5′-CGAGGCCAAAGTCTGCTATC-3′ | 684 | 60.0 | |
| | | | (Reverse; SEQ ID NO: 26) | | | |
| GAPDH | Human/Rhesus | NM_002046 | 5′-AGAAGGCTGGGGCTCATTT-3′ | 419 | 61.1 | 90 |
| | | | (Forward; SEQ ID NO: 27) | | | |
| | | | 5′-TTCACACCCATGACGAACAT-3′ | 509 | 59.8 | |
| | | | (Reverse; SEQ ID NO: 28) | | | |
| GATA1 | Human/Rhesus | NM_002049 | 5′-CTCCCCAGTCTTTCAGGTGT-3′ | 325 | 59.2 | 112 |
| | | | (Forward; SEQ ID NO: 29) | | | |
| | | | 5′-CAGTTGAGGCAGGGTAGAGC-3′ | 437 | 60.0 | |
| | | | (Reverse; SEQ ID NO: 30) | | | |
| GATA2 | Human/Rhesus | NM_032638 | 5′-GCACAATGTTAACAGGCCACT-3′ | 1469 | 60.0 | 95 |
| | | | (Forward; SEQ ID NO: 31) | | | |
| | | | 5′-GCCCCTTTCTTGCTCTTCTT-3′ | 1564 | 60.0 | |
| | | | (Reverse: SEQ ID NO: 32) | | | |
| HOXB4 | Human/Rhesus | NM_024015 | 5′-AGCACGGTAAACCCCAATTA-3′ | 513 | 59.3 | 115 |
| | | | (Forward; SEQ ID NO: 33) | | | |
| | | | 5′-CGTGTCAGGTAGCGGTTGTA-3′ | 628 | 59.8 | |
| | | | (Reverse; SEQ ID NO: 34) | | | |
| TAL1 | Human | NM_003189 | 5′-TTACTGATGGTCCCCACACC-3′ | 1110 | 60.6 | 89 |
| | Rhesus | | (Forward 1: SEQ ID NO: 35) | | | |
| | Human/Rhesus | | 5′-GGTCCCCACACCAAAGTTGT-3′ | 1117 | 62.0 | 82 |
| | | | (Forward 2: SEQ ID NO: 36) | | | |
| | | | 5′-CAAAGGCCCCGTTCACAT-3′ | 1199 | 61.9 | |
| | | | (Reverse; SEQ ID NO: 37) | | | |

Clonogenic hematopoietic progenitor assay: A clonogenic hematopoietic progenitor assay was performed as described above.

Results:

FGF-2 supplemented EB cultures showed concentration-dependent induction of hematoendothelial differentiation. When FGF-2 was added to the medium from day 8-16 of EB differentiation, rESCs and hESCs showed a dose-dependent expansion of hematopoietic and endothelial precursor populations, as defined by increased CD31, CD34 and CD45 expression. Optimal FGF-2 concentrations for induction of hematopoietic differentiation in rESCs and hESCS was 50 ng/ml and 10 ng/ml, respectively. In addition, rESCs and hESCs showed parallel increases in the frequency of double-positive CD34/CD45 and CD31/CD45 hematopoietic precursors. Therefore, FGF-2 induced dose-dependent increases in hematopoiesis in both rESCs and hESCs; however, rESCs required a five-fold increase in FGF-2 compared to hESCs for hematoendothelial differentiation.

FGF-2 induced expansion of hemangioblasts, as well as committed hematopoietic precursors. FGF-2 supplementation was performed before (i.e., day 0 to day 8) or after (i.e., day 8 to day 16) a peak appearance of hematoendothelial precursors on day 8, which typically occurs without FGF-2. rESCs exposed to FGF-2 after the peak showed a greater expansion of single-(CD31, CD34, CD45 and/or Flk-1) and double-(CD34/CD45 and/or CD31/CD45) positive hematopoietic precursors than rESCs exposed to FGF-2 before the peak. In addition, rESCs exposed to FGF-2 after the peak showed greater expansion of Flk-1/CD34/VECadherin hematoendothelial precursors than rESCs exposed to FGF-2 before the peak.

rESCs were also exposed to 100 ng/ml FGF-2 after the peak (i.e., from day 8 to day 16; for a total of 800 ng FGF-2) or exposed to 50 ng/ml before and after the peak (i.e., day 0 to day 16; for a total of 800 ng FGF-2 ). rESCs exposed to FGF-2 from day 0 to day 16 showed significantly greater hematoendothelial precursor development and hematopoietic commitment. That is, rESCs exposed to FGF-2 early on showed a greater expansion of single-(CD31, CD34, CD45 and/or Flk-1) and double-(CD34/CD45 and/or CD31/CD45) positive hematopoietic presursors than rESCs exposed to FGF-2 before the peak. Thus, FGF-2 induced an expansion of hemangioblasts.

FGF-2 supplemented culture of rESCs enhanced expression of SCL/TAL1 and GATA1 transcription factors with expanded blast colony-forming cell (BL-CFC) formation, which are transcription factors associated with regulation of hematopoietic and endothelial differentiation. Following exposure to optimal concentrations of FGF-2 (50 ng/ml for rESCs and 10 ng/ml for hESCs), rEBs and hEBs were harvested on day 8 and day 16 and examined for expression of the following transcription factors: SCL, GATA-1, GATA-2, Runx-1 and PU.1. Compared to undifferentiated rESCs and hESCs, FGF-2 supplementation through day 8 enhanced expression of GATA-1 and SCL in both rEBs and hEBs, although the effect was more pronounced in rEBs. Surprisingly, FGF-2 had marked effects on GATA-2 expression in hEBs, but not rEBs. Increased GATA-2 following FGF-2 suggested an accumulation of hematoendothelial progenitors. rEBs, however, showed increased GATA-2 by day 16, although the overall increase was not as marked as hEBs. In the clonogenic methylcellulose assay, FGF-2 significantly increased CFU-GM, CFU-M and CFU-E colony frequency. In addition, FGF-2 resulted in an expansion of BL-CFC hematoendothelial precursor colonies.

Endogenous FGF-1 and FGF-2, which are both ligands for FGFR1, did not account for a differential response to exogenous FGF-2 between rESCs and hESCs. Undifferentiated rESCs and hESCs produced similar levels of endogenous FGF-1 and FGF-2. Likewise, during hematoendothelial differentiation, both rESCs and hESCs exhibited similar patterns of FGF-1 and FGF-2 down-regulation. Thus, endogenous FGF-1 and FGF-2 concentrations do not account for the higher FGF-2 required by rESCs, as shown above.

FGFR-1 expression correlated with hematopoietic differentiation and cumulative FGF-2 supplementation. FGF-2 supplementation increased the frequency of FGFR1-expressing rEBs. However, higher doses of FGF-2 decreased the frequency of FGFR1-expressing rEBs, suggesting that FGF-2 has an inhibitor effect on differentiation at this level of supplementation. Thus, FGF-2 mediated a FGFR1-dependent switch toward hematoendothelial development (CD45 positive) in rEBs.

Interestingly, rESCs have large fractions of soluble FGFR1 (FGFR1ₛₒₗ), which may explain why rESCs require the greater exogenous FGF-2 concentration for hematoendothelial development. FGFR1 is alternatively spliced into four principle isoforms (FRFR1_{α}, FGFR1ₛₒₗ, FGFR1_{β} and FGFR1_{DNTK}), each with a diverse function. Both rESCs and hESCs expressed similar levels of cell surface FGFR1. However, rESCs (R420, R366.4 and ORMES-7) exhibited higher relative expression of FGFR1ₛₒₗ to full-length FRFR1_{α} when compared to hESCs, which was consistent in both undifferentiated ESCs and day 16 EBs. However, the relative expression of FGFR1β and FGFR1_{DNTK} were not consistently different between rESCs and hESCs. Moreover, the FGFR1_{α}:FGFR1ₛₒₗ ratio exhibited a strong correlation with the frequency of CD45 positive cells (r²=0.84) in rESCs. Accordingly, increased FGFR1ₛₒₗ may competitively sequester endogenous FGF-2, resulting in the higher demand for exogenous FGF-2 in rESCs. However, a FGFR1_{α}:FGFR1ₛₒₗ ratio of >5 correlated well with hematopoietic and hemagioblast development in both hEB and rEB cultures.

In summary, supplementation of differentiation medium with FGF-2 resulted in a dramatic expansion of hematoendothelial precursors and lingeage-committed hematopoietic precursor cell populations from both rEBs and hEBs. Although a concentration-dependent effect was observed for both species, rESCs demonstrated a 5-fold higher requirement for FGF-2 supplementation than hESCs to achieve optimal differentiation.

The invention has been described in connection with what are presently considered to be the most practical and preferred embodiments. However, the present invention has been presented by way of illustration and is not intended to be limited to the disclosed embodiments. Accordingly, those skilled in the art will realize that the invention is intended to encompass all modifications and alternative arrangements within the spirit and scope of the invention as set forth in the appended claims.

The invention claimed is:

1. A method of generating CD45-positive hematopoietic lineage cells and hemangioblast from human or non-human primate embryonic stem cells comprising the steps of:
forming embryoid bodies from embryonic stem cells; and
culturing the embryoid bodies under serum-free conditions in a differentiation medium comprising a fibroblast growth factor in an amount sufficient to yield differentiated CD45-positive hematopoietic lineage cells and hemangioblasts.

2. The method as recited in claim 1, wherein the differentiation medium also comprises stein cell factor, Flt-3 ligand and bone morphogenetic protein-4.

3. The method as recited in claim 1, wherein the differentiation medium also comprises stem cell factor, Flt-3 ligand, interleukin-3, interleukin-6, granulocyte colony-stimulating factor and bone morphogenetic protein-4.

4. The method as recited in Claim I, wherein the differentiation medium also comprises a plurality of cytokines selected from the group consisting of stem cell factor, Flt-3 ligand, interleukin-3, interleukin-6, granulocyte colony-stimulating factor and bone morphogenetic protein-4.

5. The method as recited in claim 1, wherein the differentiation medium does not comprise vascular endothelial growth factor.

6. The method as recited in claim 1, wherein the fibroblast growth factor is fibroblast growth factor-2.

7. The method as recited in claim 1, wherein the non-human primate is a rhesus macaque.

8. The method as recited in claim 1, wherein fibroblast growth factor concentration is maintained by adding fibroblast growth factor to the differentiation medium about every forty-eight hours.

9. The method as recited in claim 1, wherein fibroblast growth factor concentration is maintained by adding fibroblast growth factor to the differentiation medium daily.

10. The method as recited in claim 1, wherein the fibroblast growth factor concentration in the differentiation medium is between about 1 ng/ml to 100 ng/ml.

11. The method as recited in claim 10, wherein the embryoid bodies are derived from nonhuman primate embryonic stem cells, and the fibroblast growth factor concentration in the differentiation medium is at least about 50 ng/ml.

12. The method as recited in claim 1, wherein the fibroblast growth factor concentration in the differentiation medium is between about 0.5 ng/ml to 50 ng/ml.

13. The method as recited in claim 12, wherein the embryoid bodies are derived from human embryonic stem cells, and the fibroblast growth factor concentration in the differentiation medium is at least about 10 ng/ml.

14. The method as recited in claim 1, wherein the embryoid bodies are cultured for about eight to about sixteen days in the differentiation medium.

15. The method as recited in claim 1, wherein the CD45-positive cells are also positive for a cell surface marker selected from the group consisting of CD31 and CD34.

16. The method as recited in claim 1, wherein the embryoid bodies are cultured with stromal cells.

17. The method as recited in claim 1, wherein the stromal cells are OP9 stromal cells.

18. The method as recited in claim 1, wherein the embryoid bodies are cultured on a basement membrane matrix.

19. The method as recited in claim 1, wherein the differentiation medium is changed about every four days.

20. A cultured population of human or non-human primate hematopoietic lineage cells generated using the method of claim 1.

21. The population of cells as recited in claim 20, wherein the non-human primate is a rhesus macaque.

22. The population of cells as recited in claim 20, wherein at least 5% of the cells in the population are CD45-positive.

23. The population of cell as recited in claim 20, wherein the cultured embryoid bodies that have a FGFR1_{α}:FGFR1ₛₒₗ ratio of at least 5.

24. The population of cells as recited in claim 20, wherein a portion of the CD45-positive cells are also CD34-positive.

25. The population of cells as recited in claim 20, wherein a portion of the CD45-positive cells also CD31 -positive.

26. The population of cells as recited in claim 20, wherein at least 5% of the cells in the population are Flk-1-positive, VE-Cadherin-negative and CD45-negative.
